(19) United States
(12) Patent Application Publication
(10) Pub. No.: US 2026/0320702 A1
(43) Pub. Date: Oct. 15, 2026

(54) INFORMATION PROCESSING DEVICE AND INFORMATION PROCESSING METHOD

(71) Applicant: SONY GROUP CORPORATION, Tokyo (JP)

(72) Inventor: Takaaki HONDA, Tokyo (JP)

(21) Appl. No.: 19/484,433

(22) PCT Filed: May 2, 2024
(86) PCT No.: PCT/JP2024/016840

§ 371 Date: Nov. 14, 2025

(30) Foreign Application Priority Data
May 19, 2023 (JP) 2023-082868

(51) Int. Cl. G06Q 40/12; G06Q 10/0639; G06Q 30/018; G06Q 40/04

(52) U.S. Cl. CPC G06Q 40/125; G06Q 10/06393; G06Q 30/0185; G06Q 40/055

(57) ABSTRACT

The present disclosure relates to an information processing device and an information processing method capable of correctly evaluating an achievement of a creator.

A scoring server includes a score calculation unit that calculates an achievement score of a creator who has produced content by using an achievement VC that certifies an achievement of the creator provided by an issuing institution that issues the VC. The technology of the present disclosure can be applied to, for example, a content revenue distribution system or the like that appropriately distributes revenue on the basis of past achievements of each of a plurality of creators in a case where trade of NFT content related to a plurality of creators is established in an NFT marketplace.

### TECHNICAL FIELD

The present disclosure relates to an information processing device and an information processing method, and more particularly, to an information processing device and an information processing method capable of correctly evaluating an achievement of a creator.

### BACKGROUND ART

Many systems that trade works and content created by creators have been proposed. For example, there has been proposed a trade system that can provide a platform that accumulates useful information for creators and business operators, and enhance the fluidity of art works by utilizing a digital technology (see, for example, Patent Documents 1 and 2.) . A transaction system capable of easily performing more appropriate price evaluation for a copyright has also been proposed.

In recent years, it has become possible to add unique value to digital content by using a non-fungible token (NFT) utilizing a blockchain technology.

### CITATION LIST

### Patent Document

Patent Document 1: Japanese Patent Application Laid-Open No. 2019-82919

Patent Document 2: Japanese Patent Application Laid-Open No. 2022-120512

Patent Document 3: Japanese Patent Application Laid-Open No. 2022-106684

### SUMMARY OF THE INVENTION

### Problems to be Solved by the Invention

There is a case where a plurality of persons is involved in content production. There is no problem in a case where the revenue distribution is determined by a conventional contract. However, in a case where N-th order production can be freely performed in the world of Web3.0, a mechanism capable of automatically distributing the revenue to each producer is required. In distributing revenue, it is important to be able to correctly evaluate the achievements of creators.

The present disclosure has been made in view of such a situation, and is intended to enable accurate evaluation of achievements of creators.

### Solutions to Problems

An information processing device according to one aspect of the present disclosure includes a score calculation unit that calculates an achievement score of a creator who has produced content, using an achievement VC that certifies an achievement of the creator provided by an issuing institution that issues the VC.

In an information processing method according to one aspect of the present disclosure, by an information processing device, an achievement score of a creator who has produced content is calculated using an achievement VC that certifies an achievement of the creator provided by an issuing institution that issues the VC.

In one aspect of the present disclosure, an achievement score of a creator who has produced content is calculated using an achievement VC that certifies an achievement of the creator provided by an issuing institution that issues the VC.

The information processing device according to one aspect of the present disclosure can be implemented by causing a computer to execute a program. The program executed by the computer can be provided by being transmitted via a transmission medium or by being recorded on a recording medium.

The information processing device may be an independent device or an internal block constituting one device.

### BRIEF DESCRIPTION OF DRAWINGS

FIG. 1 is a diagram illustrating an outline of an information processing system of the present disclosure.

FIG. 2 is a diagram illustrating a mechanism of revenue distribution by the information processing system of the present disclosure.

FIG. 3 is a block diagram illustrating a configuration example of a content revenue distribution system which is an information processing system of the present disclosure.

FIG. 4 is a diagram illustrating a method of calculating a revenue distribution score.

FIG. 5 is a flowchart illustrating achievement VC score calculation processing.

FIG. 6 is a diagram illustrating contest evaluation processing in step S16 in FIG. 5.

FIG. 7 is a diagram illustrating a specific example of contest evaluation processing.

FIG. 8 is a diagram illustrating past work evaluation processing in step S17 in FIG. 5.

FIG. 9 is a diagram illustrating a specific example of past work evaluation processing.

FIG. 10 is a diagram illustrating technical school evaluation processing in step S20 in FIG. 5.

FIG. 11 is a diagram illustrating a specific example of technical school evaluation processing.

FIG. 12 is a diagram illustrating work history evaluation processing in step S22 in FIG. 5.

FIG. 13 is a diagram illustrating a specific example of work history evaluation processing.

FIG. 14 is a diagram illustrating portfolio evaluation processing in step S23 of FIG. 5.

FIG. 15 is a diagram illustrating calculation of a revenue distribution score using an achievement VC score.

FIG. 16 is a flowchart illustrating revenue distribution score calculation processing.

FIG. 17 is a diagram illustrating a screen example displayed on a display of a smartphone.

FIG. 18 is a diagram illustrating an example of executing a creator selection function.

FIG. 19 is a diagram illustrating an example of an issuing institution evaluation function.

FIG. 20 is a diagram illustrating an example of a method of adjusting an issuing institution evaluation value.

FIG. 21 is a diagram illustrating an example of revenue distribution processing using a revenue distribution score.

FIG. 22 is a block diagram illustrating a configuration example of an embodiment of a computer to which the technology of the present disclosure is applied.

### MODE FOR CARRYING OUT THE INVENTION

Hereinafter, modes for carrying out the technology of the present disclosure (hereinafter, referred to as embodiments) will be described with reference to the accompanying drawings.

Note that, in the present specification and the drawings, components having substantially the same functional configurations will be denoted with the same reference signs, and redundant descriptions will be omitted. The description will be given in the following order.
1. Outline of information processing system of present disclosure
2. Block diagram of information processing system of present disclosure
3. Configuration of revenue distribution score
4. Flowchart of achievement VC score calculation processing
5. Example of achievement VC score calculation processing
6. Calculation example of revenue distribution score
7. Creator selection function
8. Issuing institution evaluation function
9. Example of revenue distribution processing using revenue distribution score
10. Computer configuration example

### 1. Overview of Information Processing System of Present Disclosure

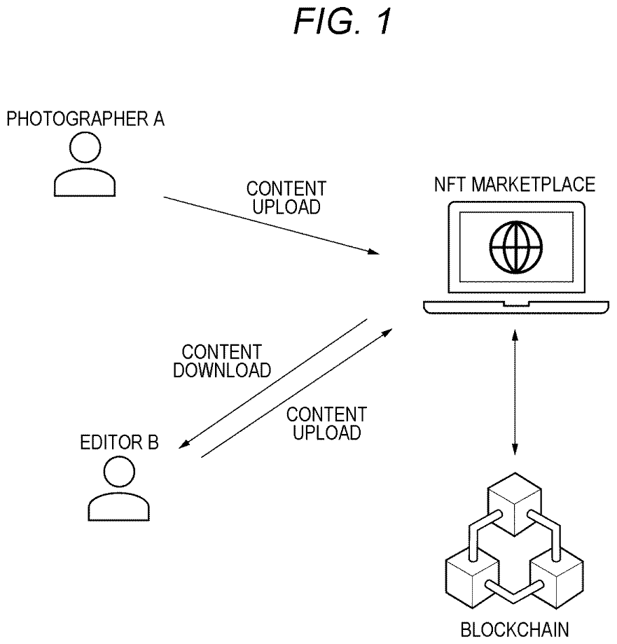

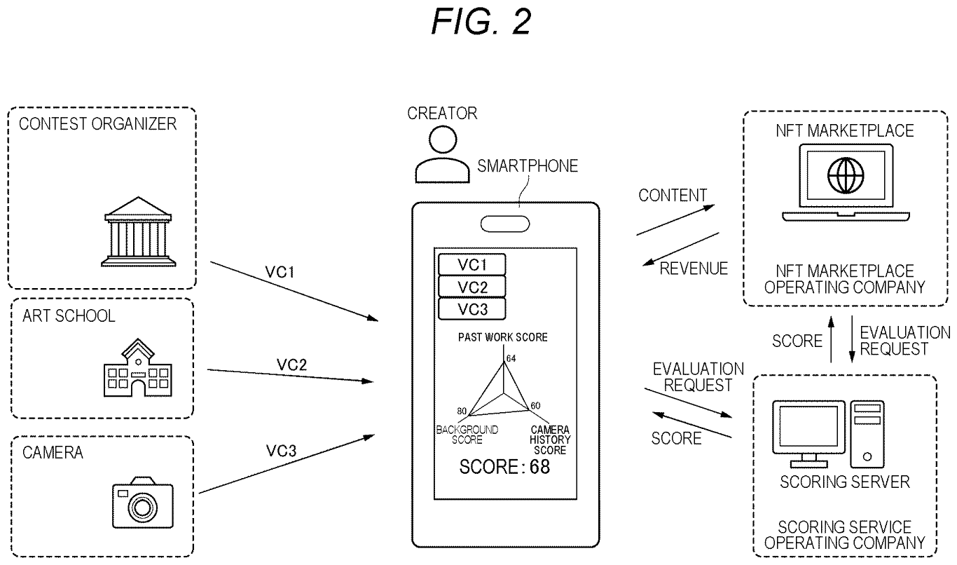

First, an outline of an information processing system of the present disclosure will be described with reference to FIGS. 1 and 2.

An information processing system of the present disclosure relates to NFT content obtained by converting digital content produced by a creator into an NFT, and is a system capable of appropriately distributing revenue to a plurality of creators involved in production of the NFT content in a case where the NFT content is traded on the NFT marketplace.

In the world of Web3.0, which is a distributed web using a blockchain technology, authenticity of NFT content can be verified, and histories of a plurality of creators involved in production of NFT content can also be recorded (verified). In a case where NFT content is co-created by a plurality of creators in the world of Web3.0 or can be freely created in the N-th order, a mechanism capable of automatically distributing revenue to each creator is required.

FIG. 1 illustrates how NET content is co-created by two creators and uploaded to the NFT marketplace. The NFT content may be digital art (illustrations, photographs), digital content such as music, or the like, but in the present example, it is assumed to be a captured image captured by a digital camera.

A photographer A uploads the content of the captured image captured by himself/herself to the NFT marketplace. The NET marketplace converts uploaded content into an NFT. That is, the NFT marketplace issues an NFT indicating that the creator is the photographer A, associates the NFT with the content, and records the NFT on the blockchain.

An editor B acquires the NET content uploaded by the photographer A on the NFT marketplace, performs editing (processing), and then uploads the NFT content to the NFT marketplace. The NFT marketplace issues an NFT indicating that the creator is the photographer A and the editor B, associates the NFT with content, and records the NFT on a blockchain.

In a case where the NFT content produced by the two creators, namely, the photographer A and the editor B as described above is traded on the NFT marketplace, how to distribute the revenue of the NFT content to the photographer A and the editor B becomes a problem.

In order to correctly evaluate a creator, the information processing system of the present disclosure uses past achievements of the creator as one of revenue distribution indices. Examples of the past achievements of the creator include winning achievements of contests, trade achievements of NFT contents (NFT works) in the past, graduation from an art school representing the specialty of the creator, and a background such as a work history. Such past achievements of the creator need to be able to verify authenticity, and also need to protect the privacy of the content producer.

The information processing system of the present disclosure enables authentication of creators and verification of past achievements by using a decentralized identity (DID) and a verifiable certificate (VC) based on a concept of a self-sovereign identity (SSI). The DID is a distributed ID managed by a blockchain, and information such as a public key associated with the DID is referred to as a DID document. The VC is a certificate for confirming authenticity of the received information.

FIG. 2 is a diagram illustrating a mechanism of revenue distribution based on past achievements of creators realized by the information processing system of the present disclosure.

The creator acquires an achievement VC, which is a VC that certifies his/her past achievements, from a VC issuing institution or the like. For example, in a case where the creator has a background of winning in a contest in the past, the creator obtains an achievement VC (VC1) indicating an achievement of winning in the contest from the contest organizer. In addition, the creator acquires an achievement VC (VC2) indicating an achievement of graduation from the art school from which the creator graduated. Furthermore, in a case where the NFT content is a captured image, the camera can generate a camera use history such as the number of years of use and the number of uses of the camera by the creator as an achievement VC (VC3).

The creator manages the achievement VC acquired by himself/herself with a smartphone. The creator operates the smartphone to transmit the achievement VC owned by himself/herself to the scoring server, and can confirm the revenue distribution score based on his/her past achievements.

In a case where the creator uploads NFT content co-produced or Nth-order produced (N>1) by himself/herself to the NFT marketplace and trade is established, the creator can acquire revenue (distribution revenue) determined on the basis of the past achievements of the creator.

The scoring server is a server device of a scoring service operating company that operates the scoring service based on the achievement, and calculates and transmits a revenue distribution score which is an evaluation value based on the achievement VC.

In a case where the trade of the NFT content is established, the NFT marketplace appropriately determines the revenue of the creator using the revenue distribution score of the creator acquired by inquiring the scoring server, and transmits the revenue to the creator. The revenue to be distributed to each of the plurality of creators who collaboratively produces or Nth-order produces NFT content is determined in consideration of, for example, a contribution rate to the NFT content in addition to the revenue distribution score.

In the current NFT marketplace, for example, in a case where trade of the NFT content produced in the third order of the photographer A, the editor B, and the editor C is established, the revenue is distributed only to the person (editor C) who converts (Mint) the NFT content after the third production into an NFT. According to the information processing system of the present disclosure, it is possible to appropriately distribute revenue on the basis of the past achievements of each of a plurality of creators involved in production. The revenue distribution rate can be visualized on the basis of the past achievements of the creator. Furthermore, the past achievements of the creator can be assumed to have enhanced reliability while protecting privacy. By assigning the achievement VC to the NFT content, it is possible to solve an oracle problem in a so-called blockchain in which reliability of data captured in the blockchain cannot be secured.

### 2. Block Diagram of Information Processing System of Present Disclosure

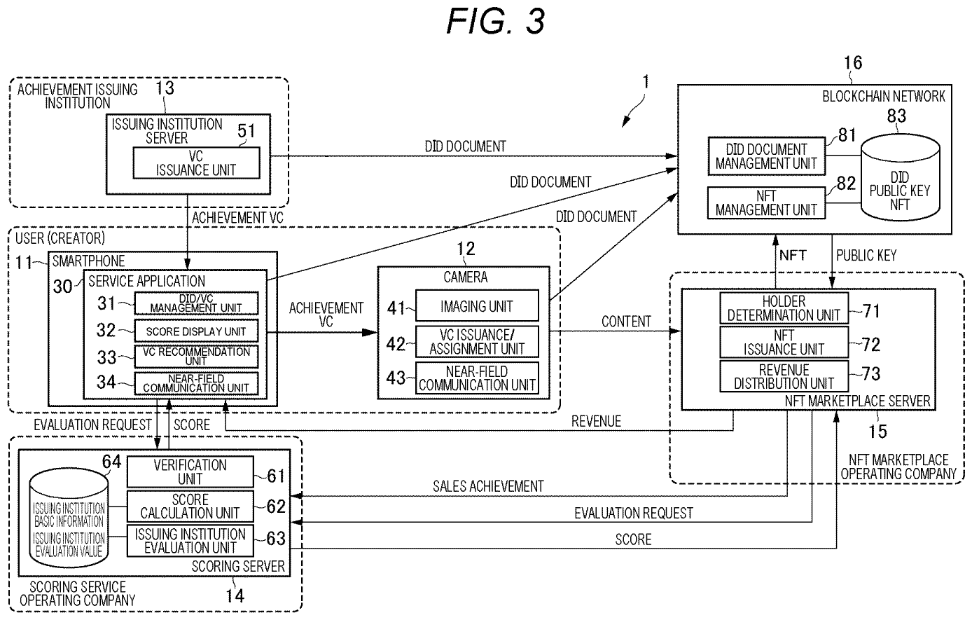

FIG. 3 is a block diagram illustrating a configuration example of a content revenue distribution system that is the information processing system of the present disclosure and realizes appropriate revenue distribution based on the achievements of the creator described above.

The content revenue distribution system 1 in FIG. 3 includes a smartphone 11, a camera 12, a plurality of issuing institution servers 13, a scoring server 14, an NFT marketplace server 15, and a blockchain network 16.

The smartphone 11 and the camera 12 are devices owned by the user, and the user is a creator who produces a captured image captured using the camera 12 as content and uploads the content to the NFT marketplace.

The issuing institution server 13 is a server device (information processing device) of an issuing institution that issues an achievement VC that certifies the past achievements of the creator. In FIG. 3, only one achievement issuing institution is illustrated for convenience of paper, but the content revenue distribution system 1 is connected to the issuing institution servers 13 of a plurality of achievement issuing institutions. The achievement issuing institution may be, for example, a contest organizer that organized the contest, an operating company of an NFT marketplace that traded the NFT content of the user in the past, a university from which the user graduated, an educational institution such as a technical school, an operating company of a website, a social networking service (SNS), or the like, a company to which the user belongs, or the like.

The scoring server 14 is a server device (information processing device) of a scoring service operating company that operates the scoring service based on the achievement VC. The NFT marketplace server 15 is a server device (information processing device) that provides an NFT marketplace for trading (purchasing, selling, or the like) NFT content obtained by converting content produced by a creator into an NFT.

The blockchain network 16 is a P2P network including a plurality of nodes, and records and manages NFTs issued for content on a blockchain. Furthermore, the blockchain network 16 manages a DID document associated with a DID that is a distributed ID (identification information) managed by a blockchain. The DID document is information including a public key or the like associated with the DID. The NFT handled by the NFT marketplace is managed by the holder on the blockchain of the blockchain network 16. In the blockchain, a history of NFT content handled by the NFT marketplace is recorded. With this blockchain, the holder of the NFT content handled by the NFT marketplace is proved.

The smartphone 11, the camera 12, the issuing institution server 13, the scoring server 14, the NFT marketplace server 15, and the blockchain network 16 include a communication unit (not illustrated), and can communicate with a required communication partner via a mobile communication network such as a so-called 4G line or 5G line, or a predetermined network such as a local area network (LAN), a wide area network (WAN), a home network, or the Internet. The predetermined network may be wired or wireless.

The smartphone 11 includes, for example, a touch panel display, an operation button, a speaker, a microphone, and the like as an operation unit and an input/output unit, and includes an arithmetic device such as a central processing unit (CPU) and a micro processing unit (MPU) that execute processing according to a software program, and a storage device such as a read only memory (ROM) and a random access memory (RAM) that store data and a program. Application software (hereinafter, it is referred to as a service application.) 30 of a scoring service provided by the scoring service operating company is installed in the smartphone 11.

Note that the smartphone 11 is an example of a device owned by the user, and another device capable of executing the service application 30, for example, a personal computer, a tablet terminal, a personal digital assistant (PDA), a portable game machine, or the like may be used instead of the smartphone 11.

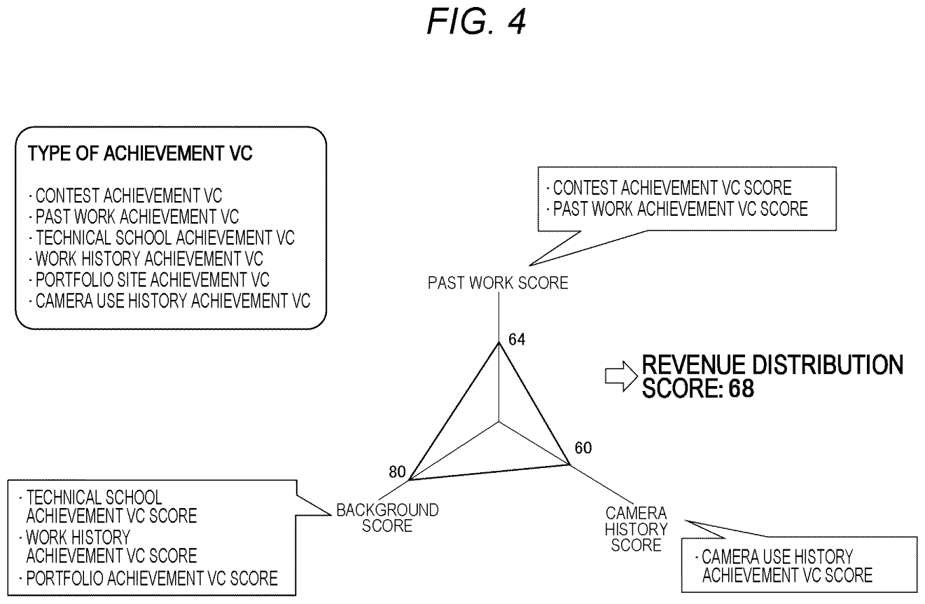

The service application 30 includes a DID/VC management unit 31, a score display unit 32, a VC recommendation unit 33, and a near-field communication unit 34. The DID/VC management unit 31 manages a user DID which is a DID for identifying a user who is a creator, and an achievement VC issued by each issuing institution server 13. The DID/VC management unit 31 holds a secret key associated with the user DID, and registers a DID document including information of a public key corresponding to the secret key in the blockchain network 16. The score display unit 32 displays a score that is an evaluation value based on the achievement VC acquired by transmitting the achievement VC of the user issued by each achievement issuing institution to the scoring server 14. The score based on the achievement VC includes an achievement VC score that is a score of an individual achievement VC and a revenue distribution score obtained by combining a plurality of achievement VC scores owned by the user. The revenue distribution score is used as one of revenue distribution indices of the user. Details of the revenue distribution score will be described with reference to FIG. 4, but the revenue distribution score is determined by comprehensive evaluation (for example, an average value of a plurality of achievement VC scores) of each achievement VC score including a plurality of evaluation axes.

The VC recommendation unit 33 recommends a beneficial achievement VC for increasing the revenue distribution score from among the achievements VC owned by the user. The near-field communication unit 34 controls a near-field wireless communication interface such as Bluetooth (registered trademark) or Wi-Fi (trademark). The near-field communication unit 34 is mainly used for communication with the camera 12 owned by the user, and transmits, for example, the achievement VC to be added to the captured image to the camera 12.

The camera 12 is, for example, a digital camera such as a digital single-lens reflex camera or a mirrorless single-lens camera. The camera 12 includes an imaging unit 41, a VC issuance/assignment unit 42, and a near-field communication unit 43.

The imaging unit 41 executes imaging in accordance with an operation of a shutter button (not illustrated) or the like, and generates a captured image as content. The captured image may be either a still image (photograph) or a moving image. The VC issuance/assignment unit 42 assigns the achievement VC acquired from (the service application 30 of) the smartphone 11 via the near-field communication unit 43 to the captured image generated by the imaging unit 41. In addition, the VC issuance/assignment unit 42 holds a secret key associated with a camera DID that is a DID for identifying the camera 12, generates an achievement VC that certifies a camera use history such as the number of years of use and the number of uses of the camera 12 by the user, and assigns the achievement VC to the captured image. The VC issuance/assignment unit 42 transmits (uploads) the captured image with the achievement VC in which the achievement VC is assigned to the captured image to the NFT marketplace server 15 via a predetermined network as content produced by the user. The content produced by the user may be transmitted to the service application 30 of the smartphone 11 by near field communication, and may be transmitted from the service application 30 to the NFT marketplace server 15. The VC issuance/assignment unit 42 registers a DID document including information of a public key corresponding to a secret key of the camera DID in the blockchain network 16. The near-field communication unit 43 has a short-distance wireless communication interface of the same communication system as the smartphone 11, and performs near field communication with (the service application 30 of) the smartphone 11. For example, the near-field communication unit 43 acquires the achievement VC to be added to the captured image from the smartphone 11, and supplies the achievement VC to the VC issuance/assignment unit 42.

The issuing institution server 13 includes a VC issuance unit 51. The VC issuance unit 51 holds a secret key associated with an institution DID that is a DID for identifying the achievement issuing institution, generates an achievement VC that certifies the achievement of the user at the achievement issuing institution, and transmits the achievement VC to (the service application 30 of) the smartphone 11. The VC issuance unit 51 registers a DID document including information of a public key corresponding to a secret key of the institution DID in the blockchain network 16.

The scoring server 14 includes a verification unit 61, a score calculation unit 62, an issuing institution evaluation unit 63, and a scoring server database (DB) 64.

The verification unit 61 performs authentication (DID authentication) of the user DID of the user of the smartphone 11 who performs imaging with the camera 12 as a creator. Furthermore, when calculating the score based on the achievement VC, the verification unit 61 verifies the achievement VC issued by each achievement issuing institution. The public key necessary for the DID authentication and the VC verification is acquired from the blockchain network 16. The score calculation unit 62 calculates the achievement VC score or the revenue distribution score of the creator using the achievement VC provided from the service application 30. Specifically, in a case where the evaluation request based on the achievement VC is transmitted from the service application 30 of the smartphone 11, the score calculation unit 62 calculates the achievement VC score or the revenue distribution score with reference to the information described in the achievement VC and the basic information of the achievement issuing institution stored in the scoring server DB 64, and returns the achievement VC score or the revenue distribution score. As will be described later with reference to FIG. 4, the revenue distribution score is calculated by comprehensive evaluation using a plurality of achievement VC scores. Even in a case where the evaluation request of the creator is transmitted from the NFT marketplace server 15, the score calculation unit 62 calculates and returns the revenue distribution score of the creator. The issuing institution evaluation unit 63 dynamically adjusts the evaluation for the achievement issuing institution stored in the scoring server DB 64 on the basis of the sales achievement supplied from the NFT marketplace server 15. More specifically, the issuing institution evaluation unit 63 increases the evaluation value of the achievement issuing institution that has issued the achievement VC assigned to the NET content whose trade has been established in the NFT marketplace server 15. The scoring server DB 64 stores basic information of each achievement issuing institution required when the score calculation unit 62 calculates a score. In addition, the scoring server DB 64 stores an evaluation value of each achievement issuing institution.

The NFT marketplace server 15 includes an rights holder determination unit 71, an NFT issuance unit 72, and a revenue distribution unit 73. In a case where content is transmitted from the camera 12 or the service application 30 of the smartphone 11, the right holder determination unit 71 determines the right holder of the content. Specifically, the right holder determination unit 71 performs DID authentication of the user of the smartphone 11 who has produced the content as the creator. Furthermore, the right holder determination unit 71 verifies the achievement VC included in the content. The public key necessary for the DID authentication and the VC verification is acquired from the blockchain network 16. The NFT issuance unit 72 issues the NFT to the content transmitted from the camera 12 or the service application 30 of the smartphone 11. The issued NFT is transmitted to the blockchain network 16 and recorded. In a case where a transaction (trade) of NFT content is established in the NFT marketplace, the revenue distribution unit 73 transmits a sales achievement indicating the transaction content to the scoring server 14. Furthermore, the revenue distribution unit 73 transmits an evaluation request to the scoring server 14, and acquires revenue distribution scores of a plurality of creators related to NFT content. The revenue distribution unit 73 determines revenue distribution rates of a plurality of creators related to NET content in consideration of the revenue distribution score and other items, for example, a contribution rate to the NET content, and distributes (transmits) revenue to each creator.

The blockchain network 16 is a P2P network including a plurality of nodes, and is, for example, a consortium-type blockchain network. A node is an information processing device (computer) that executes a computer program for confirming validity and authenticity of data to be recorded in a blockchain and recording the data for which the validity and authenticity have been confirmed in the blockchain. The blockchain includes a plurality of blocks, and the blocks store a plurality of transactions for requesting various types of processing such as reading and writing of data actually executed. Furthermore, each block also stores a nonce value assigned to each of the blocks and a hash value generated for the immediately preceding block. Therefore, the blockchain can be said to be a database in which a plurality of blocks is connected in a chain by a hash value. For example, in a blockchain, if a transaction in a block is falsified, a hash value of the block changes, so that the blockchain cannot be locally falsified.

The blockchain network 16 includes a DID document management unit 81, an NFT management unit 82, and a storage unit 83. The DID document management unit 81 manages the DID document stored in the storage unit 83. The DID document is information including a public key or the like associated with the DID. For example, the DID document management unit 81 transmits the DID document to the device of the request destination in response to a request from the scoring server 14 and the NFT marketplace server 15 at the time of verification of the achievement VC. The NFT management unit 82 stores and manages the NFT issued by the NFT marketplace server 15 in the storage unit 83. In the NFT, information regarding an owner and a producer of NFT content uploaded by a creator to the NFT marketplace (NFT marketplace server 15) is recorded. The storage unit 83 stores a DID document of each achievement issuing institution or user (creator) having a DID. In addition, the storage unit 83 stores the NFT issued by the NFT marketplace server 15.

The content revenue distribution system 1 has a configuration as described above, and in a case where NFT content uploaded by a creator to the NFT marketplace (NFT marketplace server 15) is traded, revenue can be appropriately distributed on the basis of past achievements of each of a plurality of creators involved in production. The past achievements of the creator can be assumed to have enhanced reliability while protecting privacy. By assigning the achievement VC to the NFT content, it is possible to solve an oracle problem in a so-called blockchain in which reliability of data captured in the blockchain cannot be secured.

### 3. Constitution of Revenue Distribution Score

A method of calculating the revenue distribution score will be described with reference to FIG. 4.

As illustrated in FIG. 4, the revenue distribution score is calculated by comprehensive evaluation of a past work score regarding the past work of the creator, a background score regarding the background of the creator, and a camera history score regarding the camera use history of the creator. The past work score, the background score, and the camera history score are input with an achievement VC score calculated from a predetermined achievement VC. Types of the achievements VC include a contest achievement VC, a past work achievement VC, a technical school achievement VC, a work history achievement VC, a portfolio site achievement VC, a camera use history achievement VC, and the like. The contest achievement VC is a VC indicating the achievement of winning in the contest. The past work achievement VC is a VC indicating the achievement of selling NFT works in the NFT marketplace in the past. The technical school achievement VC is a VC indicating the achievement of the technical school. The work history achievement VC is a VC indicating the achievement of the affiliation company. The portfolio site achievement VC is a VC indicating the achievement of the portfolio site. The camera use history achievement VC is a VC indicating the achievement of the camera use history. As the past work score, a contest achievement VC score using the contest achievement VC or a past work achievement VC score using the past work achievement VC can be applied. As the background score, a technical school achievement VC score using the technical school achievement VC, a work history achievement VC score using the work history achievement VC, or a portfolio site achievement VC score using the portfolio site achievement VC can be applied. As the camera history score, a camera use history achievement VC score using the camera use history achievement VC can be applied.

For example, it is assumed that a contest achievement VC score having a score of “64” is selected as the past work score, a technical school achievement VC score having a score of “80” is selected as the background score, and a camera use history achievement VC score having a score of “60” is selected as the camera history score. The score calculation unit 62 of the scoring server 14 calculates the revenue distribution score by calculating the average value of the past work score, the background score, and the camera history score. That is, since “(64+80+60)/3=68”, the revenue distribution score is calculated as “68”.

### 4. Flowchart of Achievement VC Score Calculation Processing

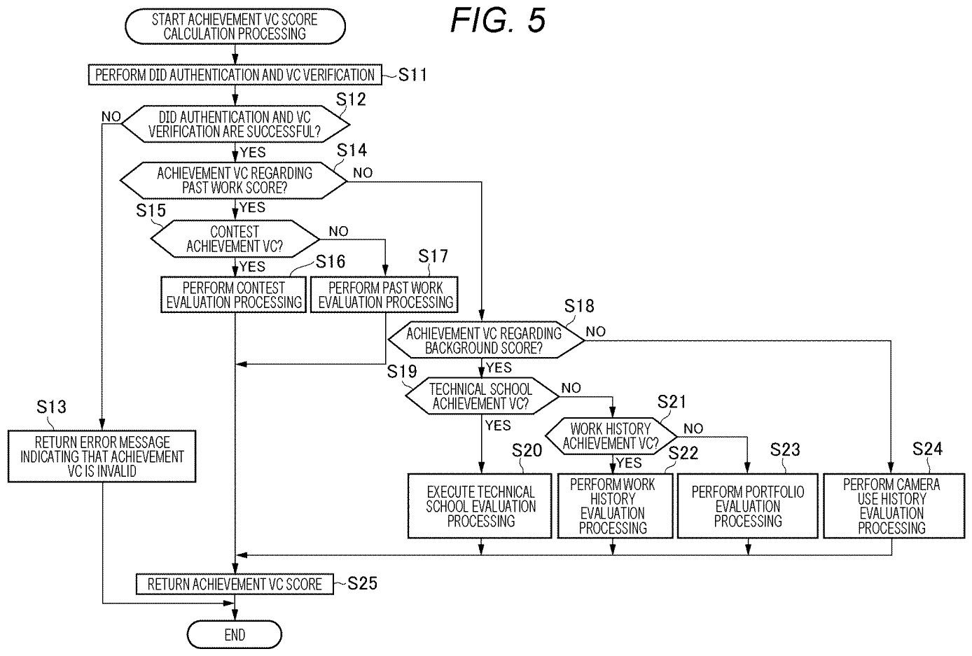

Next, achievement VC score calculation processing of calculating an achievement VC score based on a predetermined achievement VC of a user who is a creator will be described with reference to the flowchart in FIG. 5. This processing is started, for example, when an evaluation request is transmitted from the service application 30 of the smartphone 11 to the scoring server 14. The achievement VC issued to the user from a predetermined issuing institution is also provided to the scoring server 14 together with the evaluation request.

First, in step S11, the verification unit 61 of the scoring server 14 performs DID authentication of the user and VC verification of the achievement VC. The DID authentication is performed as follows, for example. The verification unit 61 acquires an authentication request from the service application 30, generates a predetermined random number, and transmits the generated random number to the service application 30 as challenge data. The service application 30 generates a signature by encrypting the hash value of the challenge data from the scoring server 14 with the secret key of the user DID, and transmits the signature to the scoring server 14 as a response. The verification unit 61 acquires a response from the service application 30 and verifies the signature. That is, the verification unit 61 acquires the DID document of the user DID stored in the blockchain network 16, and decrypts the signature acquired as a response with the public key of the user DID. Then, the verification unit 61 compares the hash value of the challenge data obtained by decryption with the hash value of the challenge data generated by itself, and verifies whether or not the hash values match each other. The VC verification of the achievement VC is performed, for example, as follows. The achievement VC includes, for example, an issuer DID, an owner DID, information (claim) of an certification target, an expiration date, a link to a revocation status list, a signature, and the like. First, the verification unit 61 acquires the DID document of the issuer, and verifies the signature included in the achievement VC with the public key of the issuer, thereby confirming that the VC is the VC issued by the issuer written in the achievement VC. Next, after confirming the expiration date, the verification unit 61 refers to the revocation status list and confirms that the VC has not been revoked. Whether the achievement VC is a VC issued to the user can be verified by, for example, DID authentication or by verifying a VP (verifiable presentation) in which a signature of a DID owner is assigned to the VC.

Next, in step S12, the verification unit 61 determines whether or not the DID authentication and the VC verification succeeded. In a case where it is determined in step S12 that the DID authentication and the VC verification have failed, the processing proceeds to step S13, and the verification unit 61 returns an error message indicating that the achievement VC is invalid to the service application 30 and ends the achievement VC score calculation processing.

On the other hand, in a case where it is determined in step S12 that the DID authentication and the VC verification succeeded, the processing proceeds to step S14, and the score calculation unit 62 determines whether the achievement VC transmitted from the service application 30 is the achievement VC regarding the past work score.

In a case where it is determined in step S14 that the achievement VC from the service application 30 is the achievement VC regarding the past work score, the processing proceeds to step S15, and the score calculation unit 62 determines whether the achievement VC is the contest achievement VC.

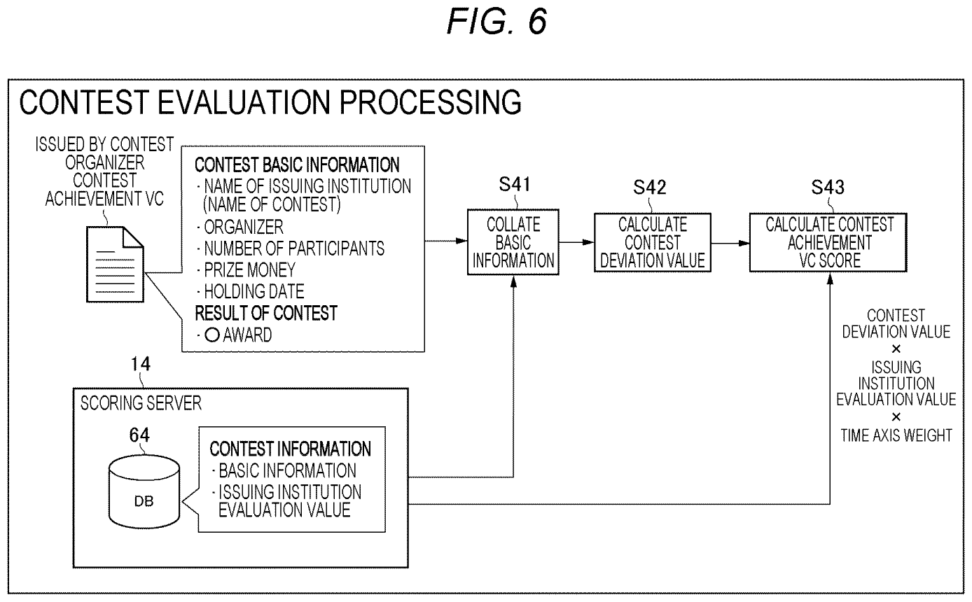

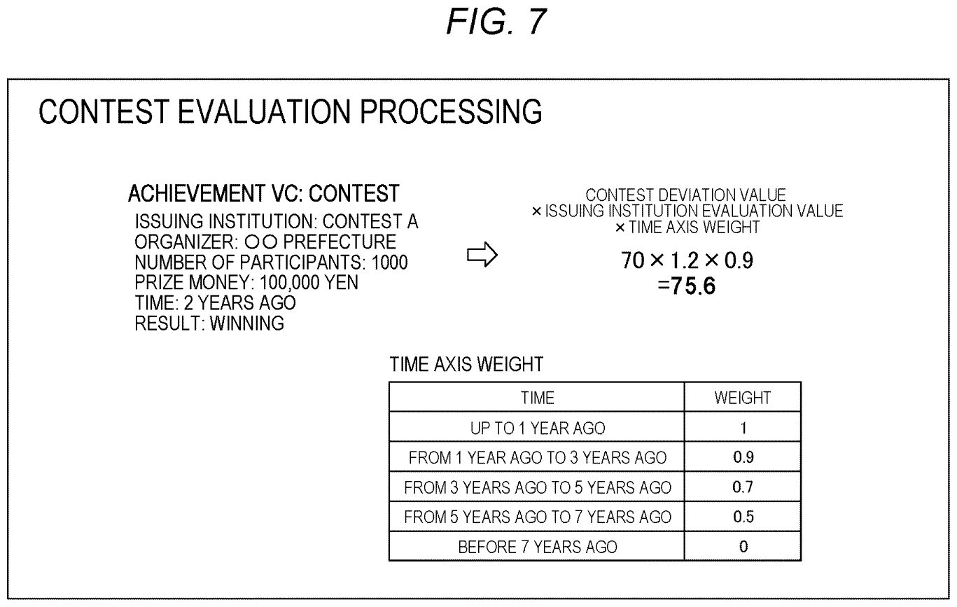

In a case where it is determined in step S15 that the achievement VC is the contest achievement VC, the processing proceeds to step S16, and the score calculation unit 62 executes the contest evaluation processing of calculating the contest achievement VC score using the contest achievement VC. A specific example of the contest evaluation processing will be described later with reference to FIGS. 6 and 7. After the contest evaluation processing ends, the processing proceeds to step S25.

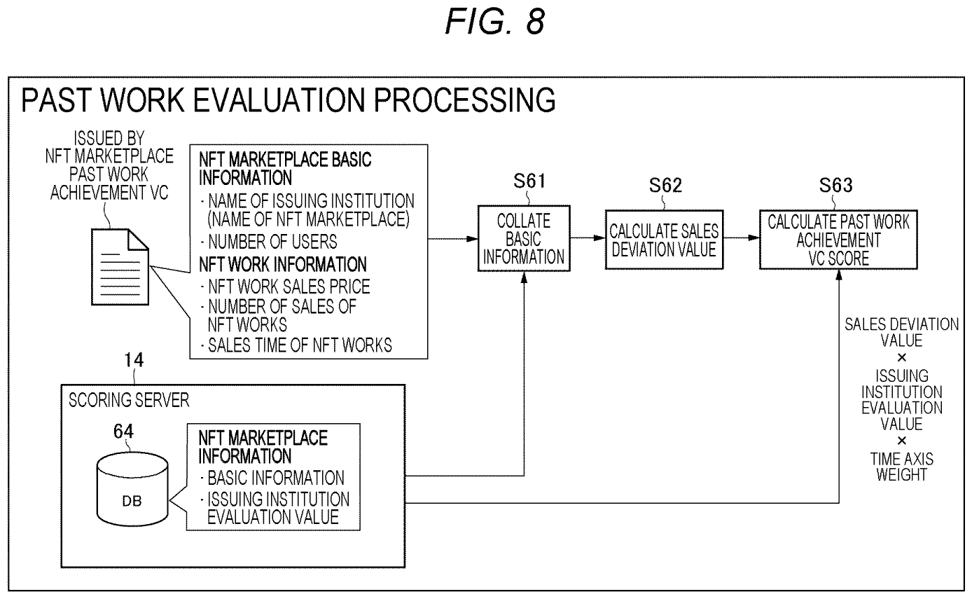

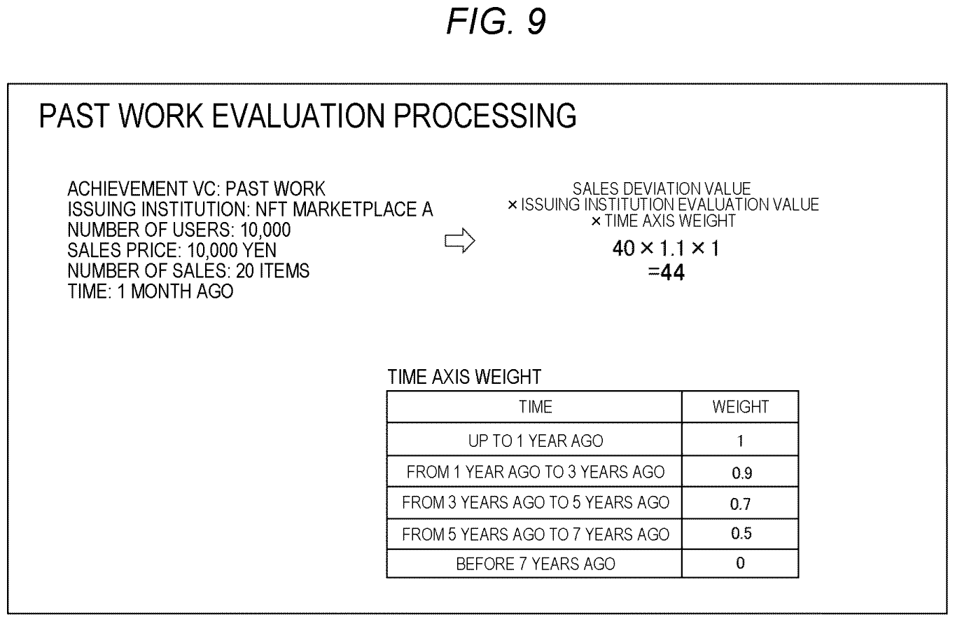

On the other hand, in a case where it is determined in step S15 that the achievement VC is not the contest achievement VC, that is, the achievement VC is the past work achievement VC, the processing proceeds to step S17, and the score calculation unit 62 executes the past work evaluation processing of calculating the past work achievement VC score using the past work achievement VC. A specific example of the past work evaluation processing will be described later with reference to FIGS. 8 and 9. After the past work evaluation processing ends, the processing proceeds to step S25.

On the other hand, in a case where it is determined in step S14 described above that the achievement VC from the service application 30 is not the achievement VC regarding the past work score, the processing proceeds to step S18, and the score calculation unit 62 determines whether the achievement VC is the achievement VC regarding the background score.

In a case where it is determined in step S18 that the achievement VC is the achievement VC regarding the background score, the processing proceeds to step S19, and the score calculation unit 62 determines whether the achievement VC is the technical school achievement VC.

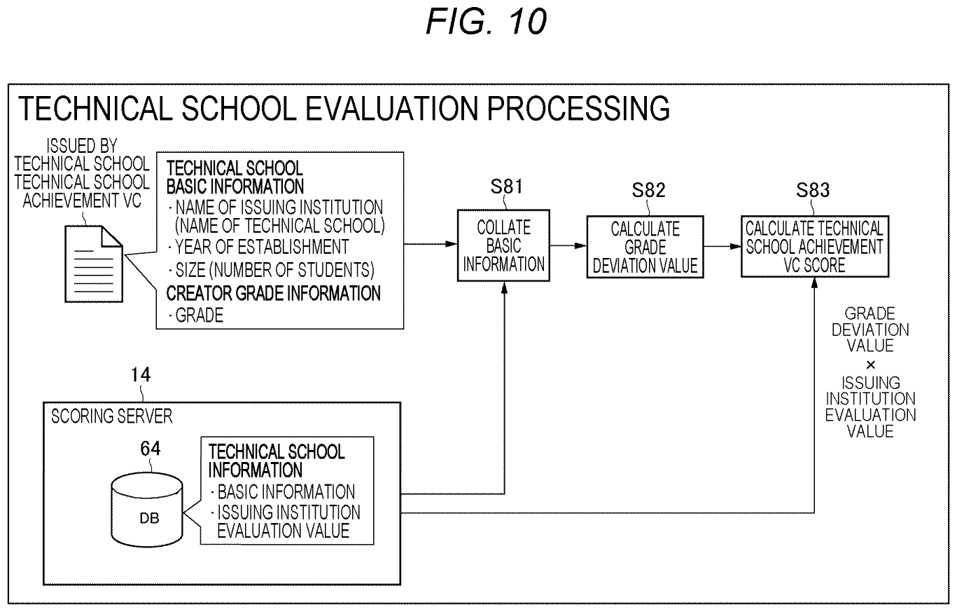

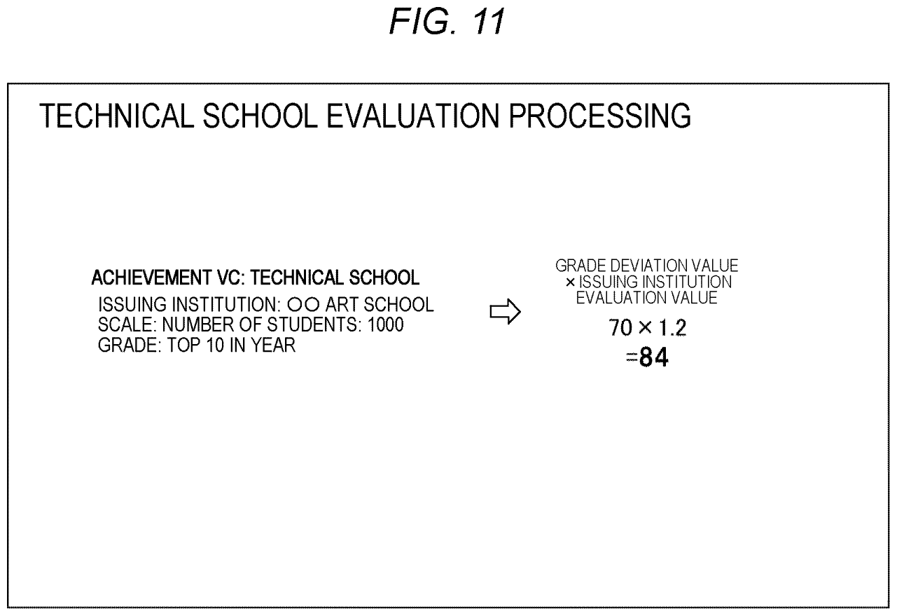

In a case where it is determined in step S19 that the achievement VC is the technical school achievement VC, the processing proceeds to step S20, and the score calculation unit 62 executes the technical school evaluation processing of calculating the technical school achievement VC score using the technical school achievement VC. A specific example of the technical school evaluation processing will be described later with reference to FIGS. 10 and 11. After the technical school evaluation processing ends, the processing proceeds to step S25.

On the other hand, in a case where it is determined in step S19 that the achievement VC is not the technical school achievement VC, the processing proceeds to step S21, and the score calculation unit 62 determines whether the achievement VC is the work history achievement VC.

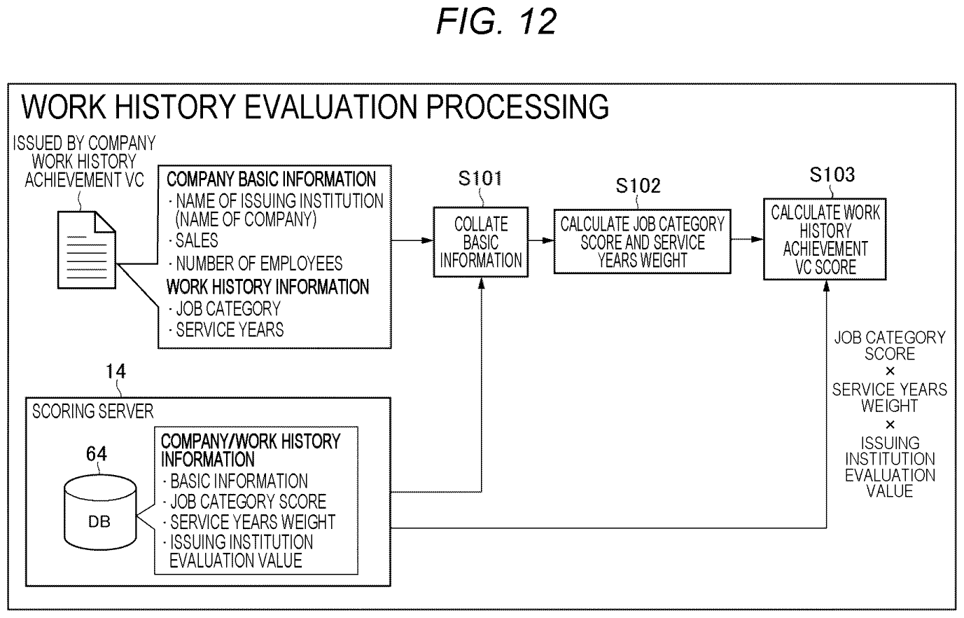

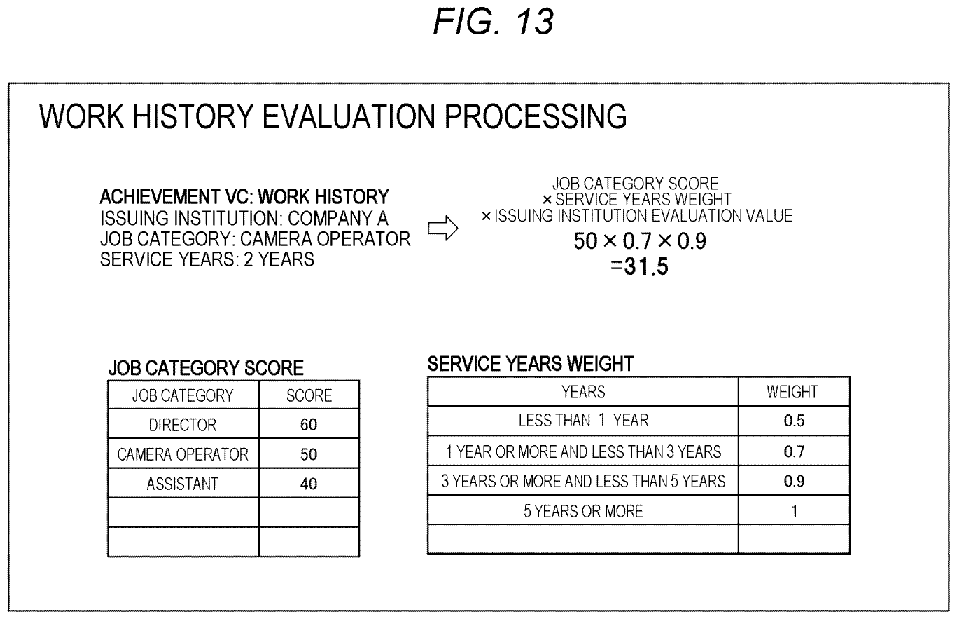

In a case where it is determined in step S21 that the achievement VC is the work history achievement VC, the processing proceeds to step S22, and the score calculation unit 62 executes the work history evaluation processing of calculating the work history achievement VC score using the work history achievement VC. A specific example of the work history evaluation processing will be described later with reference to FIGS. 12 and 13. After the work history evaluation processing ends, the processing proceeds to step S25.

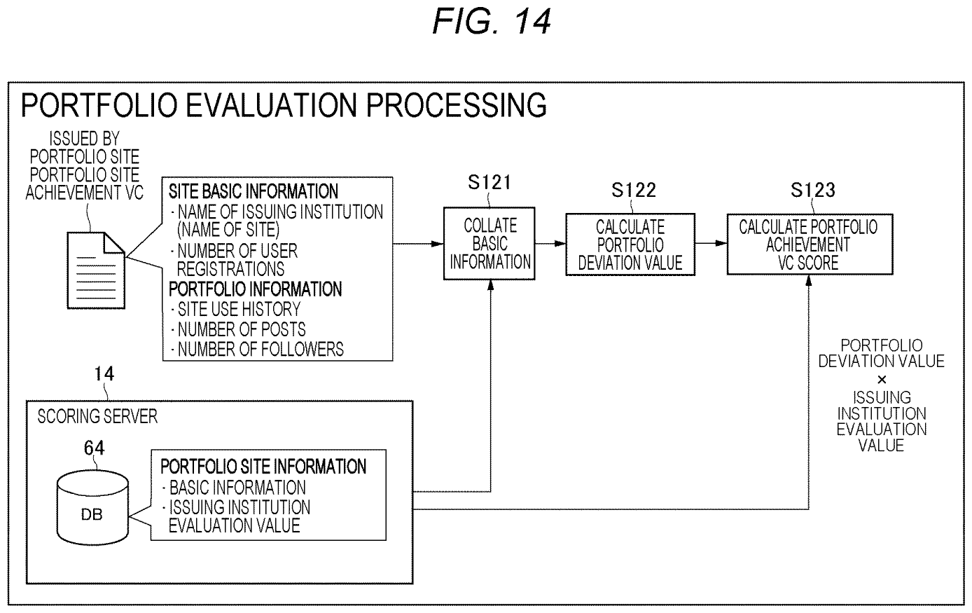

On the other hand, in a case where it is determined in step S21 that the achievement VC is not the work history achievement VC, that is, when it is determined that the achievement VC is the portfolio site achievement VC, the processing proceeds to step S23, and the score calculation unit 62 executes portfolio evaluation processing of calculating the portfolio site achievement VC score using the portfolio site achievement VC. A specific example of the portfolio evaluation processing will be described later with reference to FIG. 14. After the portfolio evaluation processing ends, the processing proceeds to step S25.

On the other hand, in a case where it is determined in step S18 described above that the achievement VC from the service application 30 is not the achievement VC regarding the background score, that is, in a case where it is determined that the achievement VC from the service application 30 is the camera use history achievement VC, the processing proceeds to step S24, and the score calculation unit 62 executes the camera use history evaluation processing of calculating the camera use history achievement VC score using the camera use history achievement VC. In the camera use history evaluation processing, the score is calculated such that the camera use history achievement VC score becomes higher as the camera use years are longer, and the camera use history achievement VC score becomes higher as the number of times of camera use is larger. After the camera use history evaluation processing ends, the processing proceeds to step S25.

In step S25, the score calculation unit 62 returns the achievement VC score calculated in the evaluation processing in step S16, S17, S20, S22, S23, or S24 to the service application 30, and ends the achievement VC score calculation processing.

### 5. Example of Achievement VC Score Calculation Processing Contest Evaluation Processing

Contest evaluation processing using the contest achievement VC executed in step S16 of FIG. 5 will be described with reference to FIG. 6.

The contest achievement VC stores contest basic information and information on results of contests indicating achievements of creators. The contest basic information includes, for example, a name of an issuing institution of the achievement VC (it may be a contest name.), an organizer of the contest, the number of participants of the contest, a prize money of the contest, a holding date of the contest, and the like. In addition, as the result of the contest, for example, “winning”, “gold prize”, “third place”, and the like are described. On the other hand, in the scoring server DB 64 of the scoring server 14, the contest basic information and the issuing institution evaluation value are stored as the contest information.

In the contest evaluation processing, first, in step S41, the score calculation unit 62 collates the contest basic information described in the contest achievement VC with the contest basic information stored in the scoring server DB 64. The score calculation unit 62 collates the contest achievement VC with the contest basic information of the scoring server DB 64, and if there is a difference that the contests are determined to be different, regards the contest achievements VC as invalid, and returns the result to the service application 30.

In a case where it is determined that the contest basic information matches, the processing proceeds to step S42, and the score calculation unit 62 calculates a contest deviation value on the basis of the information described in the contest achievement VC. When the contest deviation value is calculated, in step S43, the score calculation unit 62 calculates a contest achievement VC score. The contest achievement VC score is calculated by, for example, multiplying the contest deviation value, the issuing institution evaluation value, and the time axis weight.

FIG. 7 illustrates a specific example of the contest evaluation processing.

In the contest achievement VC and the contest basic information of the scoring server DB 64, it is described that the issuing institution is “contest A”, the organizer is “oo prefecture”, the number of participants is “1000 people”, the prize money is “100,000 yen”, and the holding date is “2 years ago”. In addition, “winning” is described as a result of the contest of the contest achievement VC.

The score calculation unit 62 calculates a contest deviation value on the basis of the contest basic information and calculates it as “70”. In the scoring server DB 64, “1.2” is stored as the issuing institution evaluation value of the contest A. In addition, as illustrated in FIG. 7, the scoring server DB 64 stores, as the time axis weight, a weight set to a larger value as the result of the recent contest is larger.

Specifically, the weight in a case where the contest time is up to 1 year ago is set to “1”, the weight in a case where the period is from 1 year ago to 3 years ago is set to “0.9”, the weight in a case where the period is from 3 years ago to 5 years ago is set to “0.7”, the weight in a case where the period is from 5 years ago to 7 years ago is set to “0.5”, and the weight in a case where the period is before 7 years ago is set to “0”.

From the contest basic information, since the time of holding the contest is 2 years ago, the time axis weight is set to “0.9”. As a result, the score calculation unit 62 calculates the contest achievement VC score as “75.6” from “70×1.2×0.9=75.6”.

### Past Work Evaluation Processing

Next, the past work evaluation processing using the past work achievement VC executed in step S17 in FIG. 5 will be described with reference to FIG. 8.

The past work achievement VC stores NFT marketplace basic information and NFT work information indicating the sales achievement of the creator. The NFT marketplace basic information includes, for example, an issuing institution name (may be an NFT marketplace name.) of an achievement VC, the number of users of the NFT marketplace, and the like. Furthermore, the NET work information includes, for example, a sales price, the number of sales, a sales time, and the like of the NET work. On the other hand, the scoring server DB 64 of the scoring server 14 stores the NFT marketplace basic information and the issuing institution evaluation value as the NFT marketplace information.

In the past work evaluation processing, first, in step S61, the score calculation unit 62 collates the NFT marketplace basic information described in the past work achievement VC with the NFT marketplace basic information stored in the scoring server DB 64. The score calculation unit 62 collates the past work achievement VC with the NFT marketplace basic information of the scoring server DB 64, and if there is a difference that the NFT marketplace is determined to be different, regards the past work achievement VC as invalid, and returns the result to the service application 30.

In a case where it is determined that the NFT marketplace basic information matches, the processing proceeds to step S62, and the score calculation unit 62 calculates the sales deviation value on the basis of the information described in the past work achievement VC. After the sales deviation value is calculated, in step S63, the score calculation unit 62 calculates a past work achievement VC score. The past work achievement VC score is calculated by, for example, multiplying the sales deviation value, the issuing institution evaluation value, and the time axis weight.

FIG. 9 illustrates a specific example of the past work evaluation processing.

In the NFT marketplace basic information of the past work achievement VC and the scoring server DB 64, it is described that the issuing institution is “NFT marketplace A”, and the number of users is “10,000 people”. Furthermore, as the NFT work information, for example, it is described that the sales price of the NFT work is “10,000 yen”, the number of sales is “20 products”, and the sales time is “one month ago”.

The score calculation unit 62 calculates the sales deviation value on the basis of the NFT marketplace basic information, and calculates it as “40”. In the scoring server DB 64, “1.1” is stored as the issuing institution evaluation value of the NFT marketplace A. In addition, as illustrated in FIG. 9, the scoring server DB 64 stores, as the time axis weight, a weight set to a larger value as the sales achievement is recent. Specifically, the weight in a case where the sales time is up to 1 year ago is set to “1”, the weight in a case where the sales time is from 1 year ago to 3 years ago is set to “0.9”, the weight in a case where the sales time is from 3 years ago to 5 years ago is set to “0.7”, the weight in a case where the sales time is from 5 years ago to 7 years ago is set to “0.5”, and the weight in a case where the sales time is before 7 years ago is set to “0”. From the NFT work information, since the sales time is one month before, the time axis weight is set to “1”. As a result, the score calculation unit 62 calculates the past work achievement VC score as “44” by “40×1.1×1=44”.

### Technical School Evaluation Processing

Next, with reference to FIG. 10, the technical school evaluation processing using the technical school achievement VC executed in step S20 of FIG. 5 will be described.

The technical school achievement VC stores technical school basic information and creator grade information indicating the grade of the creator at the technical school. The technical school basic information includes, for example, an issuing institution name (it may be a name of a technical school.) of the achievement VC, a year of establishment of the technical school, a scale (for example, the number of students), and the like. Furthermore, the creator grade information includes, for example, grade of the creator at a technical school. On the other hand, in the scoring server DB 64 of the scoring server 14, the technical school basic information and the issuing institution evaluation value are stored as the technical school information.

In the technical school evaluation processing, first, in step S81, the score calculation unit 62 collates the technical school basic information described in the technical school achievement VC with the technical school basic information stored in the scoring server DB 64. The score calculation unit 62 collates the technical school achievement VC with the technical school basic information of the scoring server DB 64, and if there is a difference that the technical schools are determined to be different, regards the technical school achievement VC as invalid, and returns the result to the service application 30.

In a case where it is determined that the technical school basic information matches, the processing proceeds to step S82, and the score calculation unit 62 calculates a grade deviation value on the basis of the information described in the technical school achievement VC. After the grade deviation value is calculated, in step S83, the score calculation unit 62 calculates the technical school achievement VC score. The technical school achievement VC score is calculated by, for example, multiplying the grade deviation value by the issuing institution evaluation value.

FIG. 11 illustrates a specific example of the technical school evaluation processing.

The technical school basic information of the technical school achievement VC and the scoring server DB 64 describes that the issuing institution is “oo art school” and the scale is “the number of students is 1000”. Furthermore, as the creator grade information, for example, “within the top 10 in the year” is described.

The score calculation unit 62 calculates the grade deviation value on the basis of the technical school basic information and calculates it as “70”. In the scoring server DB 64, “1.2” is stored as the issuing institution evaluation value of the oo art school. As a result, the score calculation unit 62 calculates the technical school achievement VC score as “84” from “70×1.2=84”.

### Work History Evaluation Processing

Next, the work history evaluation processing using the work history achievement VC executed in step S22 of FIG. 5 will be described with reference to FIG. 12.

The work history achievement VC stores company basic information and work history information indicating the work history of the creator. The company basic information includes, for example, an issuing institution name (it may be a company name.) of the achievement VC, sales of the company, the number of employees of the company, and the like. Furthermore, the work history information includes, for example, a job category, service years, and the like. On the other hand, in the scoring server DB 64 of the scoring server 14, company basic information, a job category score, a service years weight, an issuing institution evaluation value, and the like are stored as company/job category information.

In the work history evaluation processing, first, in step S101, the score calculation unit 62 collates the company basic information described in the work history achievement VC with the company basic information stored in the scoring server DB 64. The score calculation unit 62 collates the work history achievement VC with the company basic information in the scoring server DB 64, and if there is a difference that the companies are determined to be different, regards the work history achievement VC as invalid, and returns the result to the service application 30.

In a case where it is determined that the company basic information matches, the processing proceeds to step S102, and the score calculation unit 62 calculates the job category score and the service years weight on the basis of the information described in the work history achievement VC. After the job category score and the service years weight are calculated, the score calculation unit 62 calculates a work history achievement VC score in step S103. The work history achievement VC score is calculated by, for example, multiplying the job category score, the service years weight, and the issuing institution evaluation value.

FIG. 13 illustrates a specific example of the work history evaluation processing.

The company basic information of the work history achievement VC and the scoring server DB 64 describes that the issuing institution is “company A”. Furthermore, the work history information describes that the job category of the creator is “camera operator”, and the service years are “two years”. The scoring server DB 64 stores a job category score table defining scores corresponding to job categories. In the job category score table, in a case where the job category is “director”, the job category score is defined as “60”, in a case where the job category is “camera operator”, the job category score is defined as “50”, and in a case where the job category is “assistant”, the job category score is defined as “40”.Furthermore, the scoring server DB 64 stores, as the service years weight, a weight set to a larger value as the service years are longer. Specifically, the weight in a case where the service years are less than 1 year is set to “0.5”, the weight in a case where the service years are 1 year or more and less than 3 years is set to “0.7”, the weight in a case where the service years are 3 years or more and less than 5 years is set to “0.9”, and the weight in a case where the service years are 5 years or more is set to “1”.

The score calculation unit 62 calculates “50” as a job category score on the basis of the job category “camera operator” of the work history information, and calculates “0.7” as a service years weight. In the scoring server DB 64, “0.9” is stored as the issuing institution evaluation value of the company A. As a result, the score calculation unit 62 calculates the work history achievement VC score as “31” by “50×0.7×0.9=31.5”.

### Portfolio Evaluation Processing

Next, the portfolio evaluation processing using the portfolio site achievement VC executed in step S23 of FIG. 5 will be described with reference to FIG. 14.

The portfolio site achievement VC stores basic information of a portfolio site and portfolio information indicating achievements of creators. The portfolio site basic information includes, for example, an issuing institution name (it may be a portfolio site name.), the number of user registrations, and the like. In addition, the portfolio information includes, for example, a site use history, the number of posts, the number of followers, and the like. On the other hand, the scoring server DB 64 of the scoring server 14 stores portfolio site basic information, issuing institution evaluation values, and the like as portfolio site information.

In the portfolio evaluation processing, first, in step S121, the score calculation unit 62 collates the portfolio site basic information described in the portfolio site achievement VC with the portfolio site basic information stored in the scoring server DB 64. The score calculation unit 62 collates the portfolio site achievement VC with the portfolio site basic information of the scoring server DB 64, and if there is a difference that the portfolio sites are determined to be different, regards the portfolio site achievement VC as invalid, and returns the result to the service application 30.

In a case where it is determined that the portfolio site basic information matches, the processing proceeds to step S122, and the score calculation unit 62 calculates a portfolio deviation value on the basis of the information described in the portfolio site achievement VC. When the portfolio deviation value is calculated, the score calculation unit 62 calculates a portfolio site achievement VC score in step S123. The portfolio site achievement VC score is calculated by, for example, multiplying the portfolio deviation value by the issuing institution evaluation value.

### 6. Calculation Example of Revenue Distribution Score

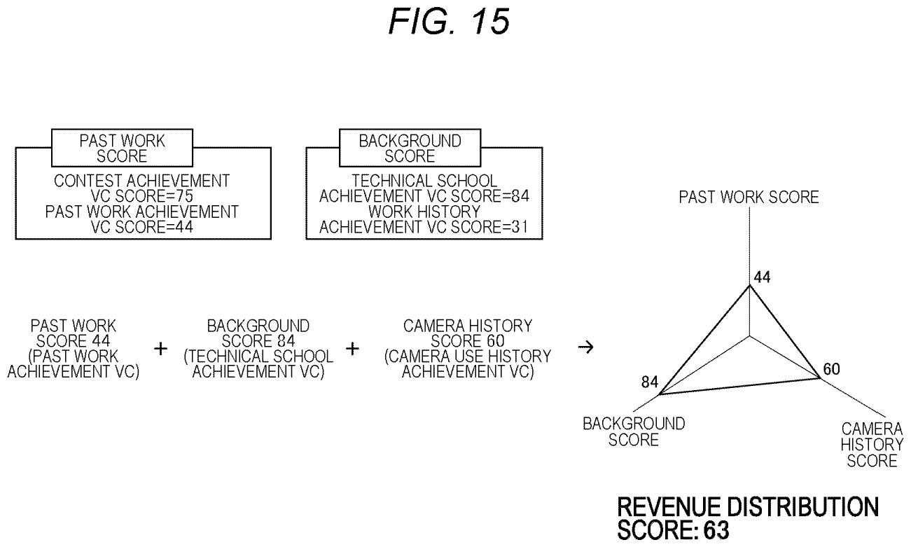

Next, the calculation of the revenue distribution score using the achievement VC score based on each achievement VC will be described with reference to FIG. 15.

As described with reference to FIG. 4, the revenue distribution score is calculated by comprehensive evaluation of the past work score, the background score, and the camera history score. For the past work score, a contest achievement VC score or a past work achievement VC score can be applied. The technical school achievement VC score, the work history achievement VC score, or the portfolio site achievement VC score can be applied to the background score. The camera use history achievement VC score can be applied to the camera history score.

The user now has the contest achievement VC illustrated in FIG. 7 and the past work achievement VC illustrated in FIG. 9 as the achievements VC that can be used for the past work scores. The contest achievement VC score using the contest achievement VC of FIG. 7 is “75”, and the past work achievement VC score using the past work achievement VC of FIG. 9 is “44”.

Furthermore, the user has the technical school achievement VC illustrated in FIG. 11 and the work history achievement VC illustrated in FIG. 13 as the achievements VC that can be used for the background score. The technical school achievement VC score using the technical school achievement VC of FIG. 11 is “84”, and the work history achievement VC score using the work history achievement VC of FIG. 13 is “31”. Furthermore, the user has the camera use history achievement VC that can be used for the camera history score, and the camera use history achievement VC score is “60”.

In the service application 30, the user can select the achievement VC to be applied to each of the past work score, the background score, and the camera history score, and confirm the revenue distribution score of himself/herself. The score display unit 32 of the service application 30 transmits the achievement VC selected by the user to the scoring server 14, and displays the revenue distribution score returned from the scoring server 14.

For example, it is assumed that the user performs an operation of selecting the past work achievement VC as the past work score, selecting the technical school achievement VC as the background score, selecting the camera use history achievement VC as the camera history score, and displaying the revenue distribution score in the service application 30. As illustrated in FIG. 15, the score calculation unit 62 of the scoring server 14 calculates a past work achievement VC score “44” using the past work achievement VC, a technical school achievement VC score “84” using the technical school achievement VC, and a camera use history achievement VC score “60” using the camera use history achievement VC, calculates an average thereof, calculates a revenue distribution score “63”, and transmits the revenue distribution score to the service application 30. The score display unit 32 of the service application 30 displays the revenue distribution score “63” on the display.

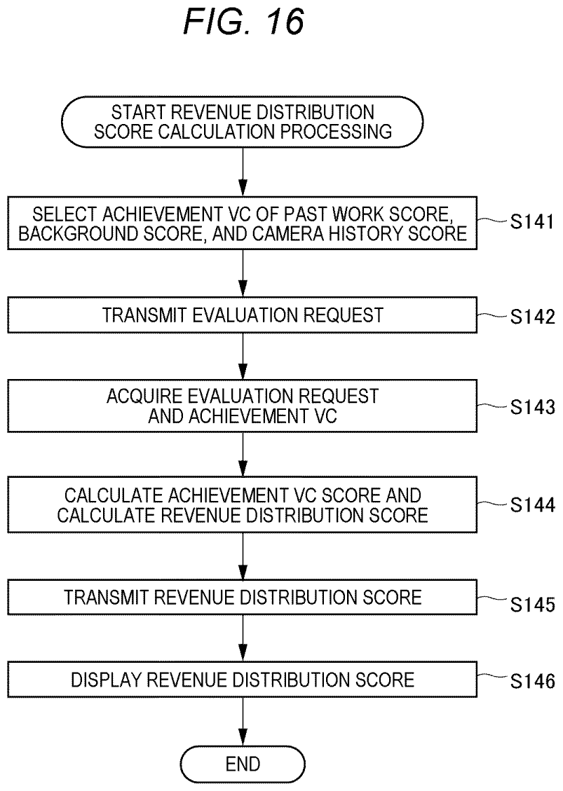

FIG. 16 is a flowchart of the revenue distribution score calculation processing executed by the smartphone 11 and the scoring server 14. This processing is executed, for example, in a case where an operation of displaying the revenue distribution score is performed in the service application 30 of the smartphone 11.

First, in step S141, the service application 30 causes the user to select the achievement VC to be applied to each of the past work score, the background score, and the camera history score. The camera use history achievement VC score applied to the camera history score is acquired from the camera 12 by near field communication.

In step S142, the service application 30 transmits the three types of achievements VC selected by the user to the scoring server 14, and transmits an evaluation request for requesting calculation of the revenue distribution score on the basis of the achievements VC to the scoring server 14.

In step S143, the verification unit 61 of the scoring server 14 acquires the evaluation request and the achievements VC transmitted from the service application 30, and executes DID authentication and VC verification. When the DID authentication and the VC verification are completed, in step S144, the score calculation unit 62 calculates the achievement VC score based on each achievement VC, and calculates the revenue distribution score by calculating an average of the three achievement VC scores.

In step S145, the score calculation unit 62 generates screen data of a revenue distribution score screen on which the calculated revenue distribution score is displayed, and transmits the screen data to the service application 30 of the smartphone 11. In step S146, the score display unit 32 of the service application 30 acquires the screen data from the scoring server 14, displays the revenue distribution score screen on the display, and ends the processing.

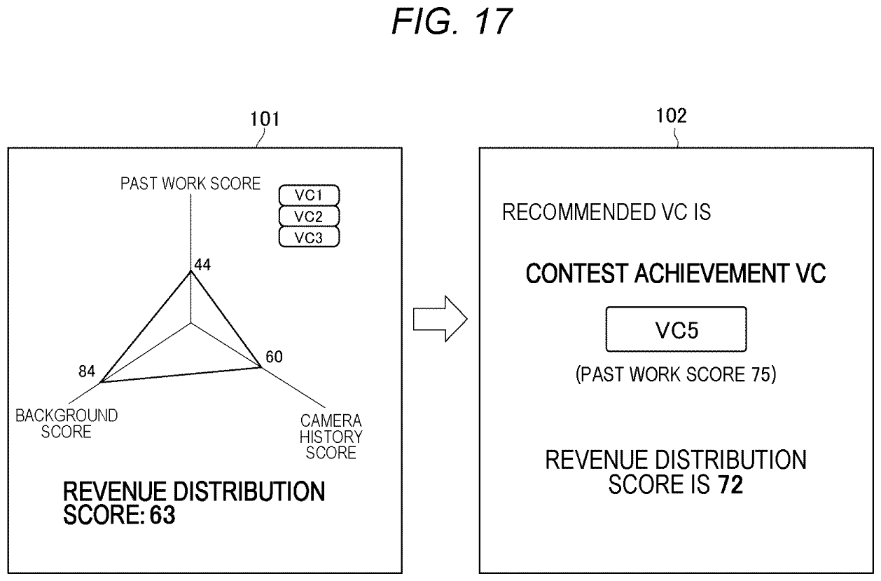

Display Example of Display FIG. 17 illustrates an example of a screen displayed on the display of the smartphone 11.

The left side of FIG. 17 is an example of a revenue distribution score screen 101 that displays the revenue distribution score calculated by the scoring server 14. On the revenue distribution score screen 101, a past work achievement VC score “44” of the past work achievement VC (VC1) selected as the past work score, a technical school achievement VC score “84” of the technical school achievement VC (VC2) selected as the background score, and a camera use history achievement VC score “60” of the camera use history achievement VC (VC3) selected as the camera history score are represented in a three-axis space, and a revenue distribution score “63” calculated by an average of the three achievement VC scores is displayed.

By the way, as described in FIG. 15, the contest achievement VC or the past work achievement VC can be applied to the past work score. If the contest achievement VC (VC5) is applied, the contest achievement VC score is “75”, so that the revenue distribution score of the user can be increased. In such a case, the VC recommendation unit 33 recommends a beneficial achievement VC for increasing the revenue distribution score from among the achievements VC owned by the user.

The left side of FIG. 17 illustrates an example of a recommendation screen 102 on which the VC recommendation unit 33 recommends the contest achievement VC (VC5) in order to increase the revenue distribution score.

On the recommendation screen 102, characters of “The recommended VC is a contest achievement VC (VC5) .” recommending a contest achievement VC (VC5) to increase the revenue distribution score, and “past work score 75” indicating a value of a past work score in a case where the contest achievement VC (VC5) is applied are displayed. In addition, on the recommendation screen 102, characters “The revenue distribution score will be 72” that present a revenue distribution score in a case where the contest achievements VC (VC5) are applied are displayed.

In the service application 30, the user transmits the achievements VC owned by himself/herself to the scoring server and causes the scoring server 14 to execute the achievement VC score calculation processing in FIG. 5, so that the user can confirm the achievement VC score of each achievement VC owned by the user and can save the achievement VC score in the smartphone 11. In a case where there is an achievement VC that can further increase the revenue distribution score among the achievements VC owned by the user, the VC recommendation unit 33 can recommend the achievement VC.

The scoring server 14 may have a VC recommendation function of recommending a beneficial achievement VC in order to increase the revenue distribution score. For example, the score calculation unit 62 of the scoring server 14 may store the achievement VC score and the revenue distribution score calculated on the basis of the evaluation request in the scoring server DB 64 for each user, and in a case where there is an achievement VC that can further increase the revenue distribution score among the achievements VC owned by the user, the achievement VC may be recommended.

### 7. Creator Selection Function

In a case where a creator collaborates with another creator or requests another creator to perform N-th order production, there may be a case where the creator desires to search for a creator with a high desired achievement VC score. The scoring server 14 can have a function of holding an achievement VC score and a revenue distribution score of each creator calculated in response to an evaluation request from each creator, and selecting a creator with a high desired achievement VC score in response to a request of the creator.

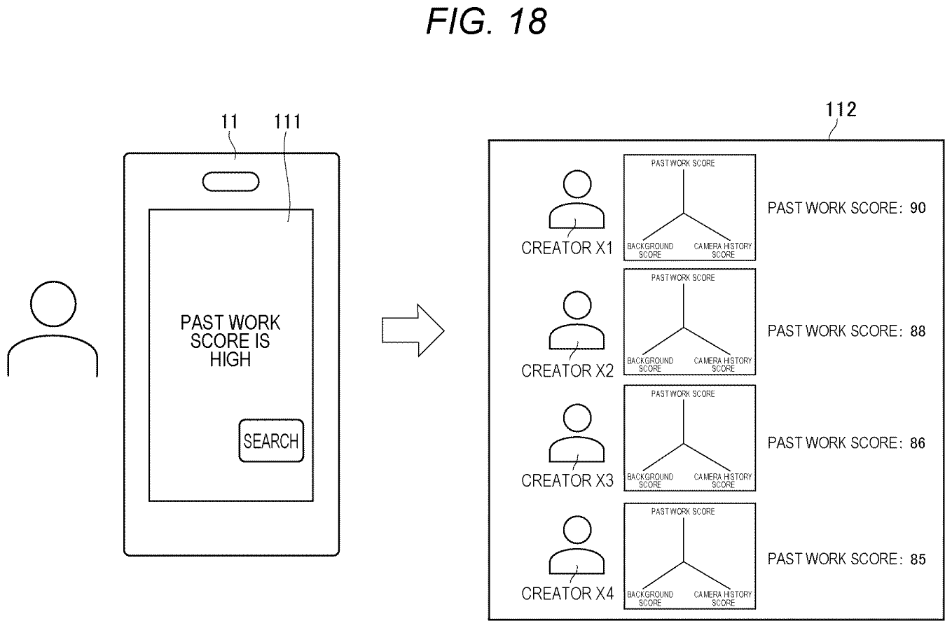

FIG. 18 illustrates an example in which the creator selection function of the scoring server 14 is executed from the service application 30.

For example, the user selects a creator selection function in the service application 30, and specifies and executes search for a creator with a high past work score on a creator selection screen 111 displayed on the display. The service application 30 transmits a search request of a creator having a high past work score to the scoring server 14. The scoring server 14 searches for a plurality of creators having high past work scores on the basis of scores of a large number of creators stored in the scoring server DB 64, generates screen data for displaying a search result, and transmits the screen data to the service application 30.

The service application 30 acquires screen data for displaying the search results of the creators and displays a creator selection screen 112 on the display.

On the creator selection screen 112 in FIG. 18, four creators X1, X2, X3, and X4 having high past work scores and the past work scores of each creator are displayed. A graph representing each score of the past work score, the background score, and the camera history score of each creator on three axes is also displayed.

This creator selection function can be executed by, for example, the score display unit 32 of the service application 30 and the score calculation unit 62 of the scoring server 14. Alternatively, the NFT marketplace server 15 may have a creator selection function. For example, when the service application 30 transmits a search request of the creator to the NFT marketplace server 15, the NFT marketplace server 15 may inquire of the scoring server 14, acquire a search result, and transmit the search result to the service application 30.

### 8. Issuing Institution Evaluation Function

Next, the issuing institution evaluation function by the issuing institution evaluation unit 63 of the scoring server 14 will be described.

The scoring server 14 stores the evaluation value of each achievement issuing institution in the scoring server DB 64. As described above, the evaluation value of each achievement issuing institution is used for calculation of the achievement VC score based on the achievement VC.

The issuing institution evaluation unit 63 dynamically adjusts the evaluation value of the achievement issuing institution stored in the scoring server DB 64 on the basis of the sales achievement supplied from the NFT marketplace server 15. More specifically, the issuing institution evaluation unit 63 performs adjustment so as to raise the evaluation value of the achievement issuing institution that has issued the achievement VC assigned to the NFT content for which the trade is established in the NFT marketplace server 15.

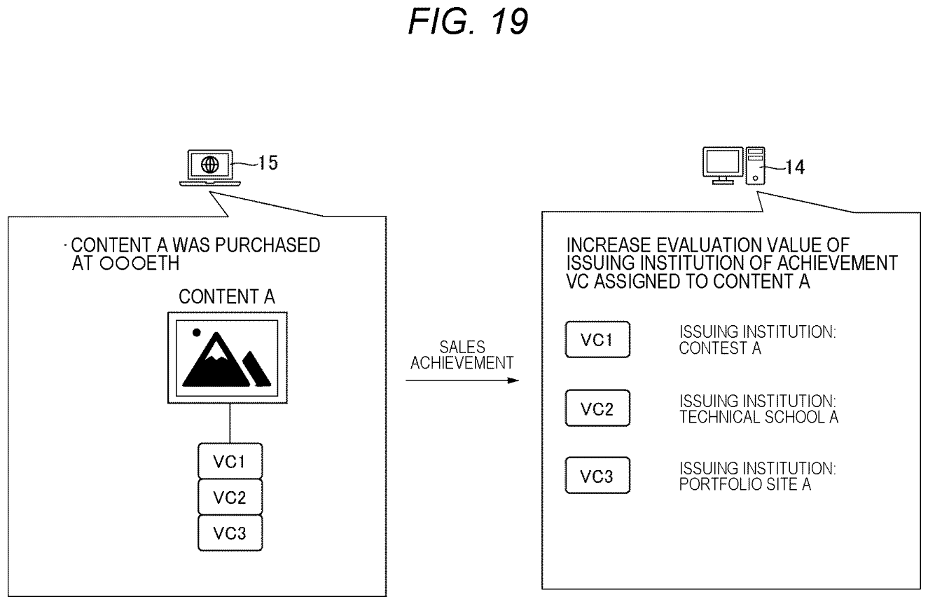

FIG. 19 illustrates an example of the issuing institution evaluation function by the issuing institution evaluation unit 63.

In the NFT marketplace of the NFT marketplace server 15, it is assumed that content A is purchased through ooo ETH (Ethereum). The content A is assigned with an achievement VC (VC1) of “Contest A” as an issuing institution, an achievement VC (VC2) of “Technical school A” as an issuing institution, and an achievement VC (VC3) of “Portfolio site A” as an issuing institution.

In a case where trade of NFT content is established in the NFT marketplace, the revenue distribution unit 73 of the NFT marketplace server 15 transmits a sales achievement indicating the transaction content to the scoring server 14. The issuing institution evaluation unit 63 of the scoring server 14 increases, on the basis of the sales achievement supplied from the NFT marketplace server 15, the evaluation value of the achievement issuing institution that has issued the achievement VC assigned to the NFT content for which the trade has been established. In the example of FIG. 19, the issuing institution evaluation unit 63 performs processing of raising the issuing institution evaluation value of “contest A”, the issuing institution evaluation value of “technical school A”, and the issuing institution evaluation value of “portfolio site A”.

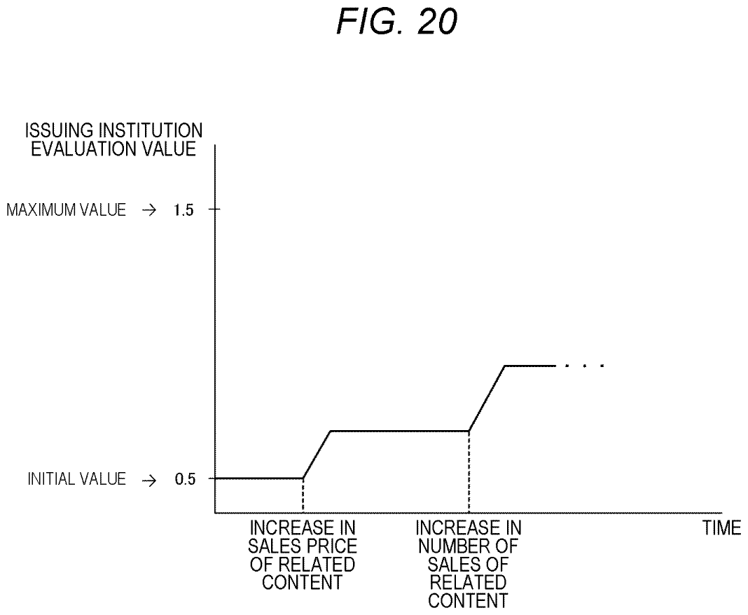

FIG. 20 is a diagram illustrating an example of a method of adjusting the issuing institution evaluation value.

For example, the issuing institution evaluation unit 63 sets the initial value of the evaluation value of each issuing institution to 0.5, and stores the initial value in the scoring server DB 64. The maximum value of the evaluation value is set to 1.5, for example. The issuing institution evaluation unit 63 increases the evaluation value by a predetermined amount in a case where a preset condition is satisfied, such as an increase in sales price of content related to a predetermined issuing institution, that is, content to which the achievement VC of the predetermined issuing institution is assigned, or an increase in the number of sales.

As described above, the issuing institution evaluation unit 63 dynamically adjusts the issuing institution evaluation value by the addition method of adding the issuing institution evaluation value by a predetermined amount according to the sales achievement. Note that the method of adjusting the issuing institution evaluation value in FIG. 20 is only addition, but it is also possible to dynamically adjust by providing a regulation for performing subtraction according to a predetermined condition.

### 9. Example of Revenue Distribution Processing Using Revenue Distribution Score

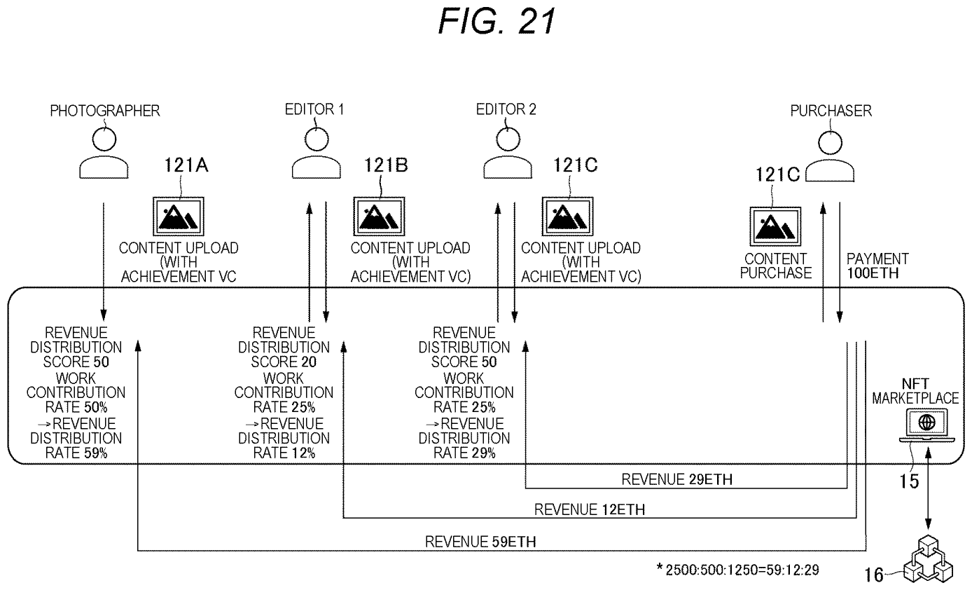

FIG. 21 illustrates an example of the revenue distribution processing using the revenue distribution score.

Contents 121 (121A, 121B, 121C) are digital contents obtained by editing a captured image captured by a digital camera, and are contents produced by three creators, namely, a photographer, an editor 1, and an editor 2, in cooperation with each other. The content 121A is a captured image captured by the photographer with the digital camera. The content 121B is an image obtained by the editor 1 editing the captured image of the content 121A, and the content 121C is an image obtained by the editor 2 editing the captured image of the content 121B. Each of the contents 121A, 121B, and 121C is uploaded to the NFT marketplace of the NFT marketplace server 15, and a history of each of the contents 121A, 121B, and 121C is recorded and managed in the blockchain network 16. In a case where the purchaser purchases the content 121C in the NFT marketplace, the NFT marketplace server 15 transmits the sales achievement to the scoring server 14. Furthermore, the NFT marketplace server 15 transmits the evaluation request to the scoring server 14, and acquires revenue distribution scores of three creators, namely, the photographer, the editor 1, and the editor 2 related to the content 121C. The revenue distribution scores of the creators, namely, the photographer, the editor 1, and the editor 2 calculated by the scoring server 14 are 50, 20, and 50, respectively.

Furthermore, in the content 121C, the work contribution rates of three creators, namely, the photographer, the editor 1, and the editor 2 are assigned as metadata. The work contribution rates of the creators, namely, the photographer, the editor 1, and the editor 2 are 50%, 25%, and 25%, respectively.

The revenue distribution unit 73 of the NFT marketplace server 15 calculates the revenue distribution rate of each creator according to the revenue distribution scores and the contribution rates (work contribution rates) to the content 121C of the three creators related to the content 121C. Specifically, the revenue distribution unit 73 calculates “50×50=2500” for the photographer having the revenue distribution score “50” and the work contribution rate “50%”, “20×25=500” for the editor 1 having the revenue distribution score “20” and the work contribution rate “25%”, and “50×25=1250” for the editor 2 having the revenue distribution score “50” and the work contribution rate “25%”, and determines the revenue distribution rate of the photographer as 59%, the revenue distribution rate of the editor 1 as 12%, and the revenue distribution rate of the editor 2 as 29% from “photographer: editor 1: editor 2=2500:500:1250=59:12:29”.

Assuming that the purchase amount of the content 121C purchased by the purchaser is, for example, 100 ETH, the revenue distribution unit 73 distributes 59 ETH to the photographer, 12ETH to the editor 1, and 29 ETH to the editor 2 according to the determined revenue distribution rate.

As described above, according to the content revenue distribution system 1, the NFT marketplace can provide a service utilizing the achievement VC score of the content producer, and can distribute revenue based on the achievement of the content producer. For the NFT marketplace, the reliability of the creator who uploads the NFT content can be confirmed. The creator side can improve reliability while protecting his/her privacy by limiting information to be passed to the NFT marketplace. There is a possibility that the credibility of the information regarding the creator is low only by providing the user DID, but the reliability can be increased by providing the achievement VC. In addition, it is possible to obtain revenue distribution in consideration of achievements.

### 10. Configuration Example of Computer

The above-described series of processing can be executed by hardware or software. In a case where the series of processing is executed by software, a program included in the software is installed in a computer. Here, examples of the computer include, for example, a microcomputer that is built in dedicated hardware, a general-purpose personal computer that can perform various functions by being installed with various programs, and the like.

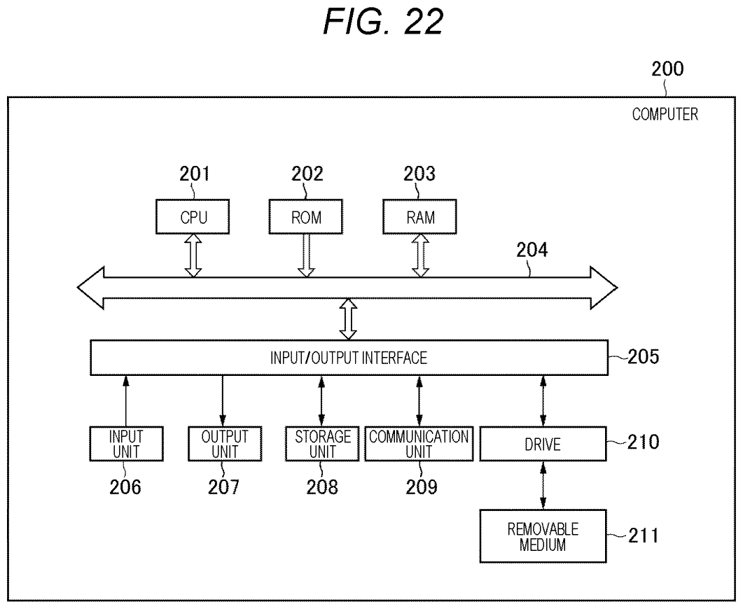

FIG. 22 is a block diagram illustrating a configuration example of hardware of a computer as a node of the issuing institution server 13, the scoring server 14, the NFT marketplace server 15, or the blockchain network 16, or a device owned by a user.

The computer 200 includes a CPU 201, a ROM 202, and a RAM 203. The CPU 201, the ROM 202, and the RAM 203 are connected to one another by a bus 204. An input/output interface 205 is further connected to the bus 204. An input unit 206, an output unit 207, a storage unit 208, a communication unit 209, and a drive 210 are connected to the input/output interface 205.

The input unit 206 includes a keyboard, a mouse, a microphone, a touch panel, an input terminal, and the like. The output unit 207 includes a display, a speaker, an output terminal, and the like. The storage unit 208 includes a hard disk, an SSD, a RAM disk, a nonvolatile memory, and the like. The communication unit 209 includes a network interface, and the like. The drive 210 drives a removable recording medium 211 such as a magnetic disk, an optical disk, a magneto-optical disk, or a semiconductor memory.

In the computer 200 configured as described above, for example, the CPU 201 loads a program stored in the storage unit 208 into the RAM 203 via the input/output interface 205 and the bus 204 and executes the program, whereby the above-described series of processing is performed. Furthermore, the RAM 203 also appropriately stores data and the like necessary for the CPU 201 to execute various types of processing.

In the computer 200, the program can be installed in the storage unit 208 via the input/output interface 205 by attaching the removable recording medium 211 to the drive 210. Furthermore, the program can be received by the communication unit 209 via a wired or wireless transmission medium such as a local area network, the Internet, or digital satellite broadcasting, and installed in the storage unit 208. Additionally, the program may be installed in advance on the ROM 202 and the storage unit 208.

The program executed by the computer 200 may be a program in which processing is performed in time series in the order described in the present specification, or may be a program in which processing is performed in parallel or as needed at a timing when a call is made, or the like

In the present specification, the steps described in the flowcharts may be executed not only, needless to say, in time series in the described order, but also in parallel or as needed at a timing when a call is made, or the like, even if not processed in time series.

In the present specification, a system means a set of a plurality of components (devices, modules (parts), and the like), and it does not matter whether or not all the components are in the same housing. Therefore, a plurality of devices housed in separate housings and connected to each other via a network and one device including a plurality of modules housed in one housing are both systems.

Embodiments of the present disclosure are not limited to the above-described embodiments, and various modifications may be made without departing from the scope of the technology of the present disclosure.

For example, a form in which all or some of the above-described embodiments are appropriately combined can be adopted.

For example, the technology according to the present disclosure can provide a configuration of cloud computing in which one function is shared and processed by a plurality of devices cooperating with each other via a network.

Furthermore, each step described in the flowcharts described above may be performed by one device, or may be performed by a plurality of devices in a shared manner. In a case where a plurality of kinds of processing is included in one step, the plurality of kinds of processing included in the one step can be executed by one device or can be shared and executed by a plurality of devices.

Note that the effects described in the present specification are merely examples and are not restrictive, and there may be effects other than those described in the present specification.

Note that the technology of the present disclosure can have the following configurations.

(1)

An information processing device including
a score calculation unit that calculates an achievement score of a creator who has produced content, using an achievement VC that certifies an achievement of the creator provided by an issuing institution that issues the VC.
   (2)

The information processing device according to (1), in which
the score calculation unit calculates an achievement score of the creator after collating information described in the achievement VC with basic information of the issuing institution stored in a database.
   (3)

The information processing device according to (1) or (2), in which
the score calculation unit calculates an achievement score of the creator using the achievement VC and an evaluation value of the issuing institution that has issued the achievement VC.
   (4)

The information processing device according to any one of (1) to (3), in which
the score calculation unit further calculates a revenue distribution score of the creator using a plurality of the achievement scores.
   (5)

The information processing device according to (4), in which
the score calculation unit further generates screen data for displaying the revenue distribution score of the creator on a display, and transmits the screen data to a device of the creator.
   (6)

The information processing device according to (4) or (5), in which
the score calculation unit further recommends an achievement VC capable of increasing the revenue distribution score of the creator.
   (7)

The information processing device according to any one of (1) to (6), in which
the score calculation unit further selects a creator with a high desired achievement score on the basis of achievement scores of a plurality of the creators.
   (8)

The information processing device according to (7), in which
the score calculation unit further generates screen data for displaying a plurality of creators having high desired achievement scores on a display, and transmits the screen data to a device of the creator.
   (9)

The information processing device according to any one of (1) to (8), in which
the achievement VC is assigned to the content.
   (10)

The information processing device according to any one of (1) to (9), further including
an issuing institution evaluation unit that adjusts an evaluation value of the issuing institution that has issued the achievement VC assigned to the content in a case where the content is traded.
   (11)

The information processing device according to any one of (1) to (10), in which
a revenue distribution rate of the content related to a plurality of creators is calculated in accordance with a revenue distribution score based on an achievement score of the creator and a contribution rate to the content.

(12)

The information processing device according to any one of (1) to (11), further including
a verification unit that authenticates the creator and verifies the achievement VC.

(13)

The information processing device according to (12), in which
the verification unit authenticates the creator by DID authentication, and verifies the achievement VC by VC verification.

(14)

An information processing method including:
calculating, by an information processing device,
an achievement score of a creator who has produced content, using an achievement VC that certifies an achievement of the creator provided by an issuing institution that issues the VC.

### REFERENCE SIGNS LIST

1 Content revenue distribution system
11 Smartphone
12 Camera
13 Issuing institution server
14 Scoring server
15 NFT Marketplace Server
16 Blockchain network
30 Service application
31 DID/VC management unit
32 Score display unit
33 VC recommendation unit
34 Near-field communication unit
41 Imaging unit
42 VC issuance/assignment unit
43 Near-field communication unit
51 VC issuance unit
61 Verification unit
62 Score calculation unit
63 Issuing institution evaluation unit
64 Scoring server DB
71 Holder determination unit
72 NFT issuance unit
73 Revenue distribution unit
81 DID document management unit
82 NFT management unit
83 Storage unit
101 Revenue distribution score screen
102 Recommendation screen
111 Creator selection screen
112 Creator selection screen
200 Computer
202 ROM
204 Bus
205 Input/output interface
206 Input unit 207 Output unit 208 Storage unit 209 Communication unit 210 Drive 211 Removable recording medium

What is claimed is:

1. An information processing device comprising
a score calculation unit that calculates an achievement score of a creator who has produced content, using an achievement VC that certifies an achievement of the creator provided by an issuing institution that issues the VC.

2. The information processing device according to claim 1, wherein
the score calculation unit calculates an achievement score of the creator after collating information described in the achievement VC with basic information of the issuing institution stored in a database.

3. The information processing device according to claim 1, wherein
the score calculation unit calculates an achievement score of the creator using the achievement VC and an evaluation value of the issuing institution that has issued the achievement VC.

4. The information processing device according to claim 1, wherein
the score calculation unit further calculates a revenue distribution score of the creator using a plurality of the achievement scores.

5. The information processing device according to claim 4, wherein
the score calculation unit further generates screen data for displaying the revenue distribution score of the creator on a display, and transmits the screen data to a device of the creator.

6. The information processing device according to claim 4, wherein
the score calculation unit further recommends an achievement VC capable of increasing the revenue distribution score of the creator.

7. The information processing device according to claim 1, wherein
the score calculation unit further selects a creator with a high desired achievement score on a basis of achievement scores of a plurality of the creators.

8. The information processing device according to claim 7, wherein
the score calculation unit further generates screen data for displaying a plurality of creators having high desired achievement scores on a display, and transmits the screen data to a device of the creator.

9. The information processing device according to claim 1, wherein
the achievement VC is assigned to the content.

10. The information processing device according to claim 1, further comprising
an issuing institution evaluation unit that adjusts an evaluation value of the issuing institution that has issued the achievement VC assigned to the content in a case where the content is traded.

11. The information processing device according to claim 1, wherein
a revenue distribution rate of the content related to a plurality of creators is calculated in accordance with a revenue distribution score based on an achievement score of the creator and a contribution rate to the content.

12. The information processing device according to claim 1, further comprising
a verification unit that authenticates the creator and verifies the achievement VC.

13. The information processing device according to claim 12, wherein
the verification unit authenticates the creator by DID authentication, and verifies the achievement VC by VC verification.

14. An information processing method comprising:
calculating, by an information processing device,
an achievement score of a creator who has produced content, using an achievement VC that certifies an achievement of the creator provided by an issuing institution that issues the VC.
